(19) United States
(12) Patent Application Publication
(10) Pub. No.: US 2002/0007294 A1
(43) Pub. Date: Jan. 17, 2002

(54) System and method for rapidly customizing a design and remotely manufacturing biomedical devices using a computer system

(76) Inventors: Thomas J. Bradbury, Yardley, PA (US); Christopher M. Gaylo, Princeton Junction, NJ (US); James A. Fairweather, West Haven, CT (US); Kathleen D. Chesmel, Cream Ridge, NJ (US); Peter A. Materna, Metuchen, NJ (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/828,504

(22) Filed: Apr. 5, 2001

Related U.S. Application Data
(60) Provisional application No. 60/194,965, filed on Apr. 5, 2000.

(51) Int. Cl. G06F 17/60

(52) U.S. Cl. 705/7

(57) ABSTRACT

A method of rapid design and manufacture of biomedical devices using electronic data and modeling transmissions, wherein such transmissions are transferred via a computer network. The method includes capturing patient-specific diagnostic imaged data, converting the data to a digital computer file, transmitting the converted data via the computer network to a remote manufacturing site, converting the computer file into a multi-dimensional model and then into machine instructions, and constructing the biomedical implant. The present invention is further directed to the preparation of rapid-prototyped pharmaceutical forms, including oral dosage pills and implantable pharmaceuticals, with transmittal of such data over computer networks being used to significantly increase the cost effectiveness and responsiveness, and is further directed to the use of a website to perform various client-interaction and follow-up tasks.

### TECHNICAL FIELD

The present invention relates generally to manufacture of biomedical devices, and more particularly, a novel method and system for rapid customized design and manufacture of biomedical implants using a computer system and transmitting data over globally based information networks such as the Internet.

### BACKGROUND OF THE INVENTION

The World Wide Web (“the Web”) is an interactive computer environment. The Web uses a collection of common protocols and file formats, including the Hypertext Transfer Protocol (“HTTP”), Hypertext Markup Language (“HTML”), SOAP (Simple Object Access Protocol), and XML (eXtensible Markup Language), to enable users to obtain information from or exchange information with a huge number of organizations, via the Internet, from virtually anywhere in the world. In order to establish a presence on the Web, organizations generally construct a “Web site.” Such a web site generally includes a collection of documents relating to the organization that is accessible by users using an address on the Web, called a Universal Resource Locator (“URL”), publicized by the organization.

The Web is increasingly used as a channel for transmitting information as well as for commercial activity. Many organizations have achieved great success at selling products and services through their web sites. For instance, a significant fraction of the airline tickets, music compact discs, and books sold today are sold via the Web.

In the medical field, the Internet and similar computer networks have proven to be useful for transmitting information for medical applications. The general term “telemedicine” refers to this practice. Telemedicine includes transmitting simple data, remotely monitoring patients' conditions, transmitting visual and pictorial information, and even transmitting instructions to remotely operate surgical instruments or medical equipment or to provide other medical instructions in real time. When visual and pictorial information was transmitted, it was frequently for the purpose of allowing diagnostics to be interpreted by specialists at a distant site, such as in U.S. Pat. No. 6,027,217 for ophthalmic data and U.S. Pat. No. 5,655,084 for radiological images, herein incorporated by reference in their entirety; see also the list of referred publications in these patents.

In surgery, however, customized manufacture of replacement material was often left up to the individual surgeon performing the surgery. Typically, surgery was sometimes performed using replacement material formed in place from autografted bone, which often included hydroxyapatite powder as filler material. Surgery was also performed with implants made from metal, plastic, ceramics or other materials by conventional manufacturing techniques typically involving machining and/or molding. In connection with using these conventional manufacturing techniques, prior to the operation the surgeon frequently prepared several different sizes of implants and then selected the best-fitting piece during the operation. Often the best-fitting piece still provided a less than satisfactory fit for medical purposes. Ill-fitting implants sometimes were less secure, failed to bond at the mating site, or required replacement. Additionally, depending on the location of the implant, cosmetic considerations may be a concern. However, since time and costs were typically critical issues, if there was not time to manufacture an individually fitted implant or if it was cost prohibitive, a best-fit piece was used. Adjusting the shape of implants during surgery, for example, by grinding off or removing material, has also been used. Carving an implant during the surgery lengthened the overall duration of the surgery as well as providing inconsistent quality of the implant dependent on the surgeon's carving skills.

Surgeons had also used prototypes or models of the patient anatomy prior to surgery to help them visualize and prepare for the actual procedure. These prototypes or models were developed from various patient data sources. The ability to quickly produce a prototype from various patient-specific data sources, however, was limited to a quality and material of prototype for use only for extra-surgical purposes, such as visualization, surgical practice, surgical planning, and design of templates. Various devices made by three-dimensional printing methods were disclosed in U.S. Pat. No. 5,490,962. The devices were of a standard geometry. The patent did not disclose machine instructions or a procedure for converting an individual's unique radiographic data into machine instructions. Further, the prior art does not provide a method for providing a rapidly manufactured customized implant, nor does it disclose the use of the Internet in transmitting such information among sites.

### SUMMARY OF THE INVENTION

The present invention provides a new method and system of rapid design and manufacture of biomedical devices using electronic data and modeling transmissions, wherein such transmissions are transferred via computer networks such as the Internet. The method includes capturing patient-specific anatomical data, converting the data to a transmittable form, transmitting the converted data to a remote site, converting the computer file into manufacturing instructions, and manufacturing the biomedical device such as an implant, preferably by rapid manufacturing methods which are suitable for medical use, and delivering it to the doctor/patient. The method may further include converting the computer file into a multi-dimensional geometric model. One example of a biomedical implant is an implantable reconstructive, augmentative, rehabilitative or cosmetic device, such as bone. One method for rapid construction of reconstructive, augmentative, rehabilitative or cosmetic devices is three dimensional printing, which involves selectively bonding together powder in successively deposited layers. Such technology allows implants to be manufactured with a great degree of design freedom and complexity as far as dimensional design, and also as far as material composition, porosity, internal architecture, and the like. In particular, it is possible to design active content into the architecture of the implant, such as drugs, DNA, growth factors, comb polymers, and the like, that can direct, promote, or discourage ingrowth of bone, soft tissues, or vascularized tissue in particular places.

The present invention significantly increases the responsiveness of the implant preparation and surgical planning process as well as allowing customized construction of the implant. In accordance with the present invention, it is possible to transmit data back and forth, individually design and dimension an implant, visualize and confirm its suitability, manufacture it, deliver the implant to the doctor and implant it in a patient, all within a few days, which is much faster than presently possible. This would greatly increase the responsiveness of the medical system, with attendant benefits to patient treatment, especially in emergency treatment. It would also reduce geographical restrictions on the availability of this medical technology.

The present invention also provides a new method of rapid design and manufacture of custom pharmaceuticals or drugs such as Oral Dosage Forms (ODF) (pills); short-run applications to meet small, acute or emergency needs; or individually designed implantable pharmaceuticals or biomedical devices, all via transmission of data over computer networks.

### BRIEF DESCRIPTION OF THE DRAWINGS

FIG. 1 is a flow diagram showing steps of the method of rapid design and manufacture of reconstructive augmentative rehabilitative or cosmetic implants in accordance the present invention.

FIG. 2 is a diagram showing steps of the method of rapid design and manufacture of biomedical devices including decision points in accordance with the present invention.

FIG. 3 is a diagram showing a centralized website to manage data and interactions with various parties in accordance with the present invention.

### DETAILED DESCRIPTION OF THE INVENTION

The present invention is directed to the preparation of rapid-prototyped implantable biomedical devices manufactured using a patient's own diagnostic imaged data. Transmittal of such data may be over telecommunication or computer networks, which significantly increases the responsiveness of the device preparation and surgical planning process as well as allowing custom manufacturing of the implant. Within the context of the present invention, data transmission implemented over a globally-based information network, such as the Internet supporting the World Wide Web, facilitates the design of an implant customized for a particular patient, allows one to visualize and confirm its suitability, and allows manufacture and delivery of the anatomically accurate implant to the doctor, all within a few days, which is much faster than presently possible. This would greatly increase the responsiveness of the medical system, with attendant benefits to patient treatment, especially in emergency treatment. It would also reduce geographical restrictions on the availability of this medical technology.

The present invention provides a new method of rapid design and manufacture of biomedical implants using electronic data and modeling transmissions, wherein such transmissions are transferred via a computer network such as the Internet. The method includes the steps of capturing patient anatomical data, converting the data to a computer file, transmitting the converted data to a remote site, converting the computer file into a multi-dimensional model and then into machine instructions, and finally manufacturing the medical device such as an implant. One example of a biomedical implant is an implantable reconstructive, augmentative, rehabilitative or cosmetic device, such as bone. Another example is a custom designed pharmaceutical such as a surgical leave behind or a custom dosage pharmaceutical. Yet another example is cartilage implants or soft tissue implants.

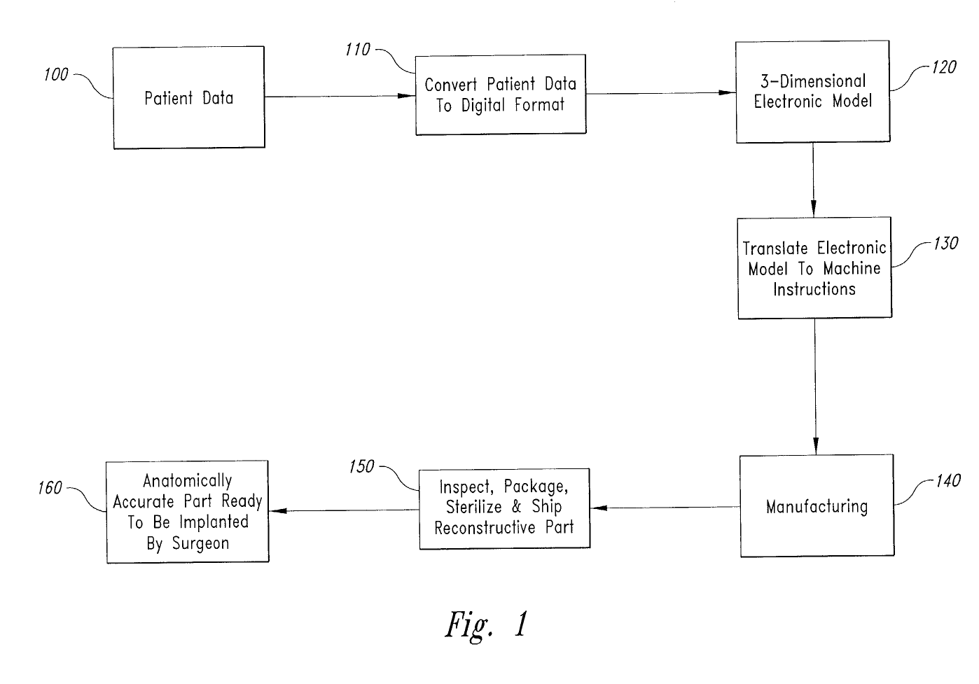

FIG. 1 is a flow diagram showing steps of the method in accordance with one embodiment of the present invention. Patient-specific data is 100 provided by the attending physician regarding the surgical or reconstruction site. This patient data 100 is converted into a digital format 110 and saved into a computer hard drive, floppy disk, compact disk, or other form of data storage. In one embodiment, after transmission of this data, a multi-dimensional model 120 is constructed from the transmitted data. Machine instructions 130 can be translated from either the multi-dimensional model 120 or from the data in digital form to facilitate an automated manufacturing 140 of the medical device such as an implant. Upon completion of the customized device or implant, the device or implant is packaged and shipped 150 to the attending physician wherein the anatomically accurate biomedical device or implant 160 is ready to be implanted in the patient or otherwise used.

In manufacturing customized implants or devices, the starting point is patient-specific information 100 obtained from various non-invasive or invasive procedures. Non-invasive procedures from which patient data may be obtained include diagnostic or radiological data such as magnetic resonance imaging (MRI) scans, computerized tomography (CT) scans, ultrasounds or nuclear medicine procedures or mammography procedures. Alternatively, standard radiographs such as x-rays may be digitized into an electronic file by either a video camera or a film scanner. Yet another type of imaging equipment, which may be useful, although only for measuring external contours of the body, is a laser scan which essentially digitizes the contours of an external surface. Details of how medical images can be stored, transmitted and handled are given in “PACS: Basic Principles and Applications,” by H. K Huang (editor), 1999 Liley-Liss, and in the same author's earlier book, “PACS: Picture Archiving and Communication Systems in Biomedical Imaging,” herein incorporated in its entirety.

The radiological imaging equipment is available at many medical facilities, but other equipment involved in the present invention is more specialized and may only be available at few centralized locations. This makes it useful to transmit diagnostic imaging information from the patient's location to a central site.

One example of a means to transmit electronic data from various sites is DICOM. DICOM or “Digital Imaging Communications in Medicine” is a standard that is a framework for medical imaging communication. It is based upon the Open System Interconnect (OSI) reference model, which defines a 7-layer protocol. The American College of Radiology (ACR) and the National Electrical Manufacturer's Association (NEMA) developed DICOM. Data may further be transmitted via common telephone lines (twisted pairs of copper wire), digital phone lines (ISDN, switched-56), DSL, coaxial cable, cable modem, fiber-optic cable, microwave, satellite, and T-1, T-3, OC-3, and other forms of telecommunications links. In regard to all data transmissions mentioned herein, privacy and security issues have become prominent issues in regard to the maintenance and transfer of individuals' medical data. Accordingly, it would be advantageous to encrypt the data before transmission and to decrypt the data after transmission, as is known in the art. Alternately, data could also be transmitted, for example, by storing the data on a data storage device such as a floppy disc, compact disc, DVD disc, optical disc, magneto-optic disc, WORM (write once read many times) disc, and sending the storage device via traditional mail services. In the event that the manufacturing site coincides with the location of the patient the doctor and the diagnostic equipment, data transmission via the Internet may not be necessary.

Patient data from, for example, MRI or CT scans is normally presented as sets of two-dimensional images (sections) showing all of the patient's tissues. The slices in a CT scan or an MRI scan associate, with each coordinate location in a scan, an intensity of brightness on the display. In the case of a CT scan, darkness corresponds to absorption of X-rays that is most closely correlated with density of the tissue. In an MRI scan, intensity refers to the presence of certain elements. CT scans are considered better for imaging hard tissue such as bone, and MRI scans are considered better for imaging soft tissue. There may be instances in which it is advantageous to use both types of imaging together with each other.

In some instances, for example, an implant that joins to existing bone, the diagnostic scans may need further processing. Further processing may include, for example, more clearly distinguishing between hard and soft tissue, as well as defining solid boundaries or surfaces of the hard tissue, for example, bone, in the two-dimensional planes or sections in which the MRI or CT scans typically are presented. Identifying the edges or surfaces of bone can be achieved by appropriate sampling and threshold definition techniques (perhaps including contrast enhancement) and geometrical algorithms such as in the software package MIMICS (from Materialise Europe; Ann Arbor, Mich.). This initially processed data may further be converted to a form that geometrically represents a multi-dimensional form representing an object. Such mathematical representations typically feature curved surfaces with resolution available to almost any desired precision anywhere on the surface, not only at locations which were part of the scan planes of the original MRI or CT data, but also in general at any location. For at least some of the types of diagnostics (MRI or CT scans), there is a coarseness in the raw data that is acquired by radiologists or medical personnel. Typically data is available at sampling planes which are parallel to each other and are spaced apart at intervals of 1 to 2 millimeters, which is coarser than the feature size typically desired in a custom manufactured implant. This increased or improved level of geometric detail is achieved through, for example, the use of interpolation, curve fitting, spline fitting, and surface fitting.

A multi-dimensional model is a geometric description of the entire surface of a solid object, where solid portions border empty space, as opposed to a description of the interior or solid region of the object. Solid surfaces are represented by patching together descriptions of individual portions of the surface together with definitions of intersections or regions in which each description applies. The descriptions of individual surface regions can in simple instances be segments of simple geometries such as planes, spheres, cylinders, toroids or other revolved surfaces. More generally the descriptions of individual surface regions can be curved surfaces of varieties such as bilinear surfaces, Coon's patch, bicubic patch, Bezier surfaces, B-spline surfaces, NURBS (non-uniform rational B-spline) surfaces, interpolation surfaces, and others as are known in the art. Intersections between surfaces can be described as series of intersection points. This information can be stored in file formats such as IGES (Initial Graphics Exchange Specifications, which is defined by ANSI Standard Y144.26M), and STEP (Standard for the Exchange of Product model data). A more limited type of data transfer is provided by DXF (Drawing Interchange Format used for AutoCAD files), and the like. Such models underlie most of the more sophisticated CAD (Computer Aided Design/Drafting) software currently in use for the engineering and design of mechanical parts.

Once a multi-dimensional model has been created from the diagnostic data, the multi-dimensional model essentially becomes just another data set or mathematical object capable of being further processed or manipulated by typical CAD software. A suitable CAD software package for further processing the multi-dimensional model is SolidWorks (SolidWorks, Concord Mass.). Another is ProEngineer (Parametric Technologies, Waltham, Mass.).

In accordance with another embodiment, data is combined from more than one type of scan, such as MRI and CT. In combining two different scans typically taken with two different sets of equipment and two different positionings of the patient, one challenge is to determine the appropriate relative position and orientation of the models obtained from the two methods. For example, CAD software is usually capable of calculating the centroid of a solid object. Aligning centroids of objects resulting from different types of scans is one way of comparing them. Alternatively, or in conjunction with aligning the centroids, the parts could be aligned as far as angular orientation. Further criterion such as mathematically subtracting one model from the other, for example, by a Boolean operation, a set of space representing points is obtained which are members of one model or the other model but not both. The volume of this could be calculated, for example, by CAD software. When the volume of this spatial difference is minimized, the best alignment of the two parts has been achieved. After the best alignment of the two versions of the bone is determined, a combination or average of the two scan results could be calculated and used for the best representation of the bone surfaces.

The multi-dimensional model created so far from diagnostic data is a model of existing bone structure in a patient's body. As a first step in creating a model of the object to be manufactured, a decision must be made as to whether the part which is to be manufactured corresponds to solid regions displayed in a diagnostic scan (i.e., if the part is a replacement part), or if it corresponds to voids displayed in a diagnostic scan (i.e., if it is a filler piece). If the part is a replacement part, it is possible that all of its edges are defined by edges of existing bone that is already represented by the multi-dimensional model. If it is a filler piece, some of its edges can be mathematically defined by Boolean operations in the CAD program where the part adjoins pieces that are already defined as solid (e.g., existing bones). Where the new part adjoins soft tissue, edges may have to be defined by the software operator. Movement to remove or move a mating bone to a position other than the position it is in during radiography could be adjusted for during the process of creating the multi-dimensional model.

In alternative embodiments, other auxiliary software such as software that is typically used by plastic and cosmetic surgeons to predict external body appearance may be used. For example, CAD software allows geometric manipulation of an original design of a part such as to add material in certain locations or to remove material in certain locations for reasons of strength, appearance, cosmetic appeal, and the like.

In yet another embodiment, other features could be added to the multi-dimensional model, involving either removal or addition of material, are features that pertain to attachment of the new part to bones or structures such as those already existing in the body. This could be, for examples, a hole for bone screws. In the case of replacement of a portion of or a complete jawbone, planning may have to be done not only for the implant of the bone itself into the jaw, but also for later implantation of artificial teeth or endosseous implants into the implant. Yet another modification could include designating dimensional reference points in the implant for use during surgery for locating the intended position of the part with respect to a template or other references, or for measuring dimensions radiologically after implantation.

In yet another embodiment, the same computerized information could be used to manufacture models out of ordinary non-sterile, non-biocompatible materials of the surgical site and/or implants, for purposes of visualization or surgical planning. Creating multi-dimensional model advantageously allows trying out different surgical approaches, attachment points, final cosmetic fit and the like.

Creating multi-dimensional models also allows templates, tools or similar related surgical hardware to be designed with the design of the implant. Those related surgical hardware items could then be supplied to the customer together with the implant, either custom made or selected from a range of sizes available from stock. It might be desirable for the surface of the implant to have a surface texture or pattern designed in to the multi-dimensional model as a feature.

Yet another geometric modification could be changing the model, for example, enlarging the entire part by a predetermined factor in all or certain directions to compensate for anticipated shrinkage during post-manufacturing processing steps. Such shrinkage is known in the art, along with how to compensate for it.

The software and computer facilities needed for this stage of the process may typically be sufficiently sophisticated, expensive or specialized that they would be unavailable at an individual doctor's office but one advantage of use of the Internet is that such facilities would be easily available at central site after transmission of the raw data out of an individual doctor's office. The multi-dimensional model may be stored, processed and transmitted in the form of an IGES, STEP or similar file, as previously described.

Beyond geometric alteration, there is also another possible step of the process of designing an implant. This step would require associating a composition variable or an internal architecture with specific geometric locations in the multi-dimensional model. Composition variation can be implemented in three-dimensional printing most clearly by dispensing various different binder liquids from different nozzles, with coordination of the nozzles so that their relative target points are known. Additionally, specific chemicals in predetermined locations may be seeded into the implant during manufacturing. For example, growth factors, DNA, etc. can encourage ingrowth of bodily tissue such as bone at designated places. Comb polymers can encourage or discourage various types of cells from locating in designated places, as can modifiers of surface hydrophobicity. Porosity of the final product can also be designed in as a variable. Depending on the desired size scale of porosity, it can be designed into the architecture or can be achieved by manufacturing details, as is known in the art. Color, including variations of color, could also be designed in if desired. It would be possible to put in marker substances that show up on MRI or other forms of radiography, so that the part can be better inspected later. For example, two or more markers could be designed in to the part at a known distance apart from each other. Depending on the modeling software, it may be possible to associate these details with the multi-dimensional model at this stage. If such compositional details are not incorporated into the multi-dimensional model, they can be incorporated at the next stage, namely the machine instruction file.

Other design conveniences are also possible. For example, because the nearby bones and the proposed new part all exist as multi-dimensional models, it is possible to assemble them to give a complete description of what the final site will look like. CAD software is capable of checking for mechanical interferences and can further check for assemble ability. Assemble ability of the system includes, for example, the assembly sequences, geometric tolerances and tolerance stack-up, design clearances, insertion and motion paths for parts as they are moved into place, all of which are directed toward avoiding interferences of ordinary mechanical parts as they are being assembled.

In another embodiment, sections of the multi-dimensional models can be calculated in orientations that resemble those of the original diagnostic radiographs for purposes of comparison. Thus, the doctor/patient can view what a CT, MRI, simple X-ray, or other diagnostic should look like after implantation of the proposed part. Software for visualizing the exterior of the human body, such as software used for planning plastic and cosmetic surgery, could further help visualization. If modeling rules for ingrowth of bone or reabsorption of implant material into the body are known, it would even be possible to simulate the time-progression of growth processes after the implant is implanted in the patient. This simulation could be transmitted back to the doctor nearly instantaneously by means of the computer network.

In yet another embodiment of the present invention, a multi-dimensional model can be used to create a mesh for finite element analysis, for example, stress distribution due to applied loads. Such analysis, which is linked to the multi-dimensional model derived from the patient-specific radiological data, could provide patient-unique calculated stress margins with respect to defined loads. Such stress analysis could, for example, be performed at the remote facility providing the modeling services. The stress analysis could be part of the process of consulting with and obtaining approval from the doctor.

In one embodiment, the designed multi-dimensional model data is transmitted back to the doctor/patient for their review. Multiple review iterations may be performed as changes are discussed and agreement is reached with the doctor/patient. A system that is implemented in hardware could allow a substantial number of design iterations in a short period of time particularly if it operates in near real time. Further, such a system could provide the medical field a capability of concurrent design or collaborative or interactive design. The final multi-dimensional model file can be transmitted over the Internet to the manufacturing machine if that machine is located at still another location. Thus, the computer facilities and software that process the radiological data to form the multi-dimensional model do not have to be co-located with the manufacturing facility.

In yet another embodiment, various details are transmitted back to the client or doctor for viewing along with the multi-dimensional model. If the transmittal of proposed designs from the remote location back to the doctor is done by files such as IGES or STEP, it will be possible to transmit as much geometric detail as desired, but it may not be possible to transmit much compositional detail such as distributions of color on the surface, or other compositional variation such as placement of bioactive substances. IGES would be more limiting than STEP in this respect. If the transmission of data is done with proprietary file formats tied to the software of a particular CAD software vendor, it may require that the doctor/patient location use the same software for viewing the image of the proposed part. For transmission of the multi-dimensional model back to the doctor/patient for viewing, it is not necessary for the doctor/patient to have a complete license to the CAD software which was used in making the patient-unique multi-dimensional model; many software packages nowadays are offer simplified versions whose only capability is to open and display files generated by that program, without actually being able to modify them. Alternatively, the computer terminal at the doctor/patient could simply be configured as a remote user of the software that is installed at the central computer.

Encryption would be desirable in any such data transmission. Transmission of approval from the doctor to the manufacturer can be stored with the file containing the agreed-upon design, forming a record of much like a conventional written record of a doctor's prescription.

One method of constructing the devices of the instant invention, namely the reconstructive, augmentative, rehabilitative or cosmetic devices, is three-dimensional printing. Three-dimensional printing (3DP) involves selectively bonding together powder in successively deposited layers to form generalized solid shapes of great complexity. Three dimensional printing processes are detailed in U.S. Pat. Nos. 5,204,055, 5,387,380, 5,807,437, 5,340,656, 5,490,882, 5,814,161, 5,490,962, 5,518,680, and 5,869,170, all hereby incorporated by reference. In three-dimensional printing, there are two principal ways of depositing a layer of powder. In some cases a roller spreads a layer of dry powder. In other cases a continuously dispensing jet moving back and forth in a raster pattern until an entire layer is deposited deposits a layer of slurry typically. The latter method is typically used for depositing relatively thin layers of relatively small particle dimension powder, compared to roller spreading. Either method could be used for present purposes depending on requirements for feature size, mechanical strength of the finished part, and other variables as are known in the art.

The choice of binder liquid is also of importance and is selected for particular applications as is known in the art. The binder liquid can be dispensed by a drop-on-demand print head, which may be a piezoelectric print head, or a continuous-jet-with-deflection printhead, or others as are known in the art.

Since the process is intended here for medical use, the equipment must include certain medical-unique features, for example, with respect to sterility, as are known in the art. Furthermore, the use of printing materials, including powder, binder and any subsequent filling, infusing or other processing materials, should be compatible with the human body. Biocompatible substances for all these materials are known in the art.

Since three-dimensional printing involves printing in layers, it requires instructions in which a multi-dimensional model is mathematically translated into a series of slices of narrow thickness, with each slice having a set of data or printing instructions representing the part geometry at that particular plane. In three-dimensional printing, each slice corresponds to a layer of powder in the powder bed during construction of the object. The entire set of data or instructions is referred to as the machine instructions.

In a general sense, the slices which are the manufacturing instructions bear a general resemblance to the scan planes which make up an MRI scan or CT scan, but there are important differences. The slices in an MRI or CT scan are acquired diagnostic data. The slices that are manufacturing instructions are processed data containing additional information. The slices that are the manufacturing instructions are typically spaced at the layer thickness of powder spreading, rather than at the scan planes interval of MRI or CT. Quite possibly, the powder layer spacing interval is much smaller than the scan plane interval of the MRI or CT.

Additionally, the angular orientation at which the manufacturing slices are taken does not need to have any particular orientation with respect to the angular orientation of the scan planes of MRI or CT. The scan planes are for convenience of diagnostic imaging, and the manufacturing slices are for convenience of manufacturing.

The slices in a CT scan or an MRI scan associate with each coordinate location in a scan and an intensity of brightness on the display. In the case of a CT scan, darkness corresponds to absorption of X-rays that is most closely correlated with density of the tissue. In an MRI scan, intensity refers to the presence of certain chemical elements. Both of these types of quantities can have a whole range of values (i.e., analog). In contrast, the print instructions for any given coordinate location are in many cases essentially digital, instructing particular dispensers to either dispense or not dispense.

Generating the machine instructions includes mathematically taking a cross-section of the multi-dimensional model at locations corresponding to the layers of the three-dimensional printing process. The machine instructions describe the entire interior solid structure of the manufactured part, whereas the multi-dimensional model merely describes the surface.

Generating the machine instructions for each coordinate point in the powder array or printing region include a determination as to whether that coordinate point is to be bound powder and therefore part of the solid or is to be left as unbound powder and therefore empty space the final part.

The motion of the printhead as it moves along the fast axis can be considered a line or a ray that intersects the multi-dimensional model. This is especially true for raster printing, in which the motion of the printhead is always along a straight line, as opposed to vector printing, in which the motion of the printhead can be a curved path. That intersection can be mathematically calculated to indicate for each point or printing location along the ray whether that point should have a dispense command or no command. This process is called ray casting, and basically amounts to mathematically calculating intersections between lines and the multi-dimensional model. For example, each intersection point between the ray and the surface can be characterized as an entry or an exit. If an entry point has already been reached but no exit point has been reached along that ray, then all points on the ray between entry and exit are part of the solid and require dispensing of binder. Thus, the machine instructions include instructions to dispense or not to dispense binder liquid at each of many locations in the printing plane, usually in a grid format.

In another embodiment, more than one binder or dispensed liquid may be involved in order to dispense different substances at different locations. To accomplish this, the independent instructions for each available binder liquid instruct whether to dispense or not to dispense at a particular location. This can further include a check to prevent certain multiple dispensing of binders at given locations. Thus, the machine instructions at each possible printing point are a series of digital (yes-or-no) instructions for each of the available dispensers.

In some types of printheads it is even possible to control or vary the amount of liquid dispensed at a given print command, as is known in the art, by varying the electrical waveform driving the dispenser. The printhead technologies most likely to provide this capability are piezoelectric printheads and microvalve based printheads. In such a case, additional information would have to be associated with each print command in the machine instruction file.

Thus, in addition to the geometric data, the machine instruction file also contains compositional information relating to the situation where more than one binder substance is dispensed onto the powder.

The method just described provides a method of manufacturing biomedical devices such as implants that yield at least superior dimensional matching to the patient's body and hence should promote superior tissue and bone ingrowth as compared to conventional methods. In general, the smaller the gap between fragments or surfaces which are intended to heal to each other, the greater the likelihood of successful healing is believed to be. The implants of the present invention are anatomically accurate, thus providing an optimal fit with the patient's anatomy, which should promote healing. Furthermore, internal microarchitectures can be designed into the implant to promote, guide, or discourage ingrowth of bone or other tissue in specific places. The configuration of the architecture provides an environment beneficial to and optimized to cell ingrowth, and further can be designed to create a unique cell-surface interface that facilitates rapid and specific cell migration into the implant. This is possible due to specifically designed architecture as well as the ability to place drugs, gene fragments, comb polymers, and growth factors in specific locations within the implant. Such details are included in the machine instruction file as just described. Using the machine instruction file, the device is manufactured such as by three-dimensional printing. It is then inspected, sterilized if required, packaged, and delivered to the user.

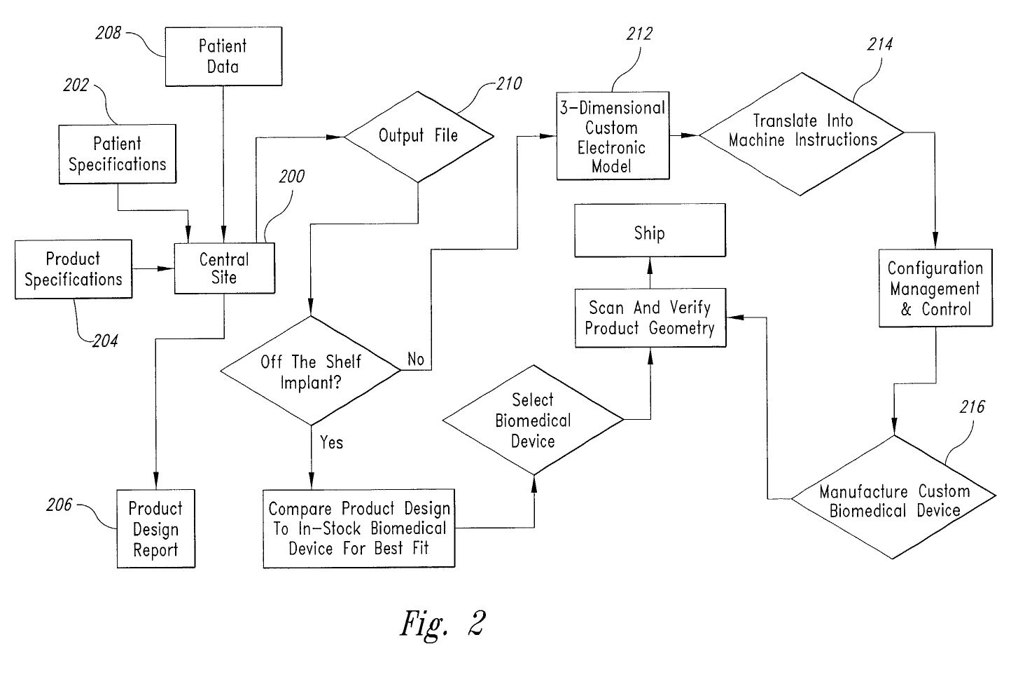

FIG. 2 is a diagram further showing steps of the method and illustrating the flow of data and certain decision points in the process in accordance with the present invention that more specifically illustrates the interaction of a central site. The central site receives data from remote sites, engages in some processing of that data and interaction with remote sites, and finally is involved in the manufacturing and shipping of parts to remote sites. At a central site 200, information is processed. Patient specifications 202, patient data 208 in the form of an MRI or CT scan, product specifications 204 or dimensions for the implant, and product design 206 requirements are integrated at the central site 200.

Processing of the raw patient data 208 such as the CT/MRI scan together with patient specifications 202, and product specifications 204 involves transmission of data via the Internet and can involve interaction with the patient and/or physician so as to determine choices of features of the device such as an implant to be manufactured. A multi-dimensional model of the proposed implant may be constructed and may incorporate additional details or features as previously described. The use of network computer communications also permits return transmittal of information from the central location to the doctor/patient.

In accordance with the present invention, the design can be done interactively or collaboratively in nearly real time allowing the doctor/patient to make suggestions and the CAD operator to enter them, even if the doctor/patient are located a great distance away from the CAD operator. This collaboration is facilitated by the use of the Internet or similar interactive telecommunication network. Information may be transmitted back to the treating doctor showing how a proposed device would fit into the patient's body. Although the dimensions of the reconstructive, augmentative, rehabilitative or cosmetic device are probably the most common subject of customization, there are also other parameters which may also be interactively tried and sampled and viewed between physically separated locations, such as material composition of the implant, gradients of properties, porosity, additives, color, and the like. Such visualizations can be returned via the computer network to the doctor for evaluation.

Such a system, particularly if it operates in near real time, could allow a substantial number of design iterations in a short period of time, and could provide the medical field a capability of concurrent design or collaborative or interactive design. In addition to simply indicating the fit and attachment of the reconstructive device, such information may be generally useful in planning surgical strategy, patient post-operative appearance as previously described

FIG. 2 further shows a decision point as to whether or not to accept the design, approve the order, and initiate manufacture. At this point the multi-dimensional model file 212 resulting from the consultative process would be further translated into manufacturing instructions 214 as previously described, and the manufacturing instructions would in turn be used to manufacture custom biomedical device 216.

In addition to custom manufacturing a device, such as an implantable reconstructive, augmentative, rehabilitative or cosmetic device, from a patient's unique diagnostic data such as an MRI/CT scan, a customized best fit can be achieved. For example, patient-unique data can be transmitted to a remote site and then used to decide whether one of a number of standard designs is appropriate for the patient and which one is the best fit. Then, this standard design can be shipped directly from stock if available. Upon final agreement, the implant device would be retrieved from stock if it were in stock or could be manufactured to order, but with less specific labor and effort than is involved in a fully customized design. Depending on various factors such as price, timing, and the location in the body of the implant, customization can include either a best fit from standardized sizes or a one of a kind customized construction. The implant is then shipped to the doctor, and is implanted in the patient.

There are several differences between a completely customized implant and a best fit from stock implant. If an implant is a completely customized implant, it would have the best possible matching to a patient's own dimensions, as a result of being custom-manufactured, and presumably only one of them would be made. Presumably the multi-dimensional model and the resulting machine instructions would both be fairly complex. On the other hand, if it is decided that a fully customized implant is not necessary, there are two other possibilities. One is to supply an implant that is fully customized for another patient who closely resembles the current patient. The files would probably be similarly complex, but would not be correct to the same level of detail for the individual patient. Another way would be to design a multi-dimensional model that is a generic part, not derived from the specific data of any particular patient. Such a model would probably be less detailed, and more of these parts would probably be manufactured simultaneously at a lower manufacturing cost.

In three-dimensional printing, economics pushes toward printing a whole tray or bed full of similar parts in one run. Thus, if generic parts were being manufactured, it would be preferable to manufacture a substantial number of them simultaneously. This means assembling a machine instruction file in which instructions for the generic part repeat themselves a substantial number of times. If patient-specific parts are being manufactured, it would also be preferable to manufacture a substantial number of parts in one run, which would mean stringing together the individual print instructions for a number of different patients' parts to make one complete set of printing instructions or machine instruction file.

Through all of the techniques described here, the ability for matching or customization of the reconstructive augmentative rehabilitative or cosmetic device to a patient's individual needs is maximized, and the amount of information available to the surgeon before the operation is maximized, while the time needed for a better product to be manufactured is minimized.

The present invention's use of an electronic design and manufacturing model also permits additional advantages such as compilation of databases or profiles for individual doctors/hospitals or for individual patients, inventory control, record-keeping and billing, product design updates and client feedback, and follow-up notices to users. Such information can be maintained on a secure web site that is made available to appropriate categories of users such as through the use of passwords or similar access restrictions.

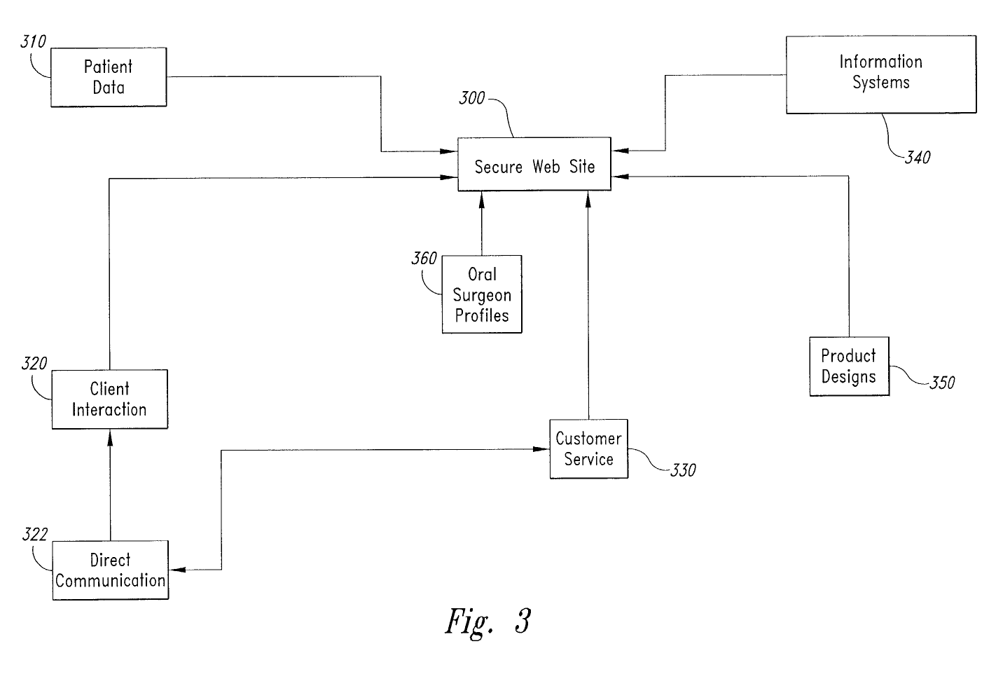

FIG. 3 is a diagram showing steps of the method in accordance with the present invention with emphasis on the functions of a website. Access to the website or appropriate portions of the website for specific users or categories of users can be controlled by passwords or similar methods. In order to provide for privacy of medical records, encryption could be used for all data transmissions. As shown in FIG. 3, a secure web site 300 is created to allow for the management of patient profiles including orders for reconstructive implants, and for direction and review by the attending physician, for example, an oral, maxillofacial, orthopedic or other surgeon. Patient records and histories can be maintained. The responsibilities of the secure web site 300 include accepting the input of patient specifications or the facilitation of imaging data such as an MRI/CT collection, initiating an initial proposal for the product design for the patient, a display of the multi-dimensional viewable models of the implants, management of the client feedback and commentary, and the maintenance of order status through delivery of the implant to the client. Thus, the secure web site 300 provides a central information exchange platform.

The patient data 310, including specific imaging data such as MRI/CT files, provide the basis for developing the customized implant. The client interaction 320 includes, inter alia, an initial patient profile, a review of the proposed product, comments and questions regarding the product, and an approval of the final order. Client interaction 320 can be via email, telephonically or through traditional mail routes. Client interaction 320 may be initiated through direct contact 322 or via a customer service 330 operation.

Customer service 330 serves to respond to inquiries regarding customized implants as well as match product designs to patient specifications and facilitate the ordering process. Customer service 330 also may provide electronic mail updates or alerts regarding the implant, may respond to client's queries via telephone, mail, or electronic mail, and may facilitate direct sales. An information system 340 provides control of implant data, inventory control, web management and billing.

The final product design 350 can be viewed on the secure web site 300 prior to manufacture and/or shipment, and files can be stored in the information system 340 for future reference. The secure web site 300 may also allow the client, for example, the oral or maxillofacial or other surgeon 360 to directly input specifications, requests, or parameters. The website can maintain a permanent record of the doctor's instructions in ordering the part, so as to function in much the same way as a prescription.

Yet another use of a secure central website could be as a facility for comparing data taken on a given patient at different times, even for the purpose of obtaining specific dimensional comparisons or changes. In taking a CT scan or a MRI scan, data is taken at a series of imaginary planes through a patient's body, with the planes typically being spaced from each other by a distance of 1 to 2 mm. For two different scans taken a substantial amount of time apart from each other, the positioning of the patient will likely not be the same each time, and even if it were, the position of the imaginary planes at which scans are taken would not be the same. Thus, for obtaining detailed dimensional data, it is useful to transform the raw CT or MRI data to a multi-dimensional model. A multi-dimensional model involves defining boundaries such as between soft tissue and bone, by defining the edges of bone, and then in all multi-dimensions fitting curves to define the surfaces of the bone throughout space.

Furthermore, for comparing dimensions of such data taken from the same patient at different times, it is advantageous to use the multi-dimensional model processed from the raw CT or MRI data, because the multi-dimensional model contains the detailed calculated positions of curved surfaces throughout space, rather than just at locations at which scans were actually taken. Once the position of a given body part in one multi-dimensional model is suitably related to the position of the same body part in a multi-dimensional model from a scan at a different time, differences in dimensions can be calculated, and increments of recession or growth can be calculated. This matching could be done as previously described by calculating centroids and matching their position, together with orientating the two models so that the mathematical or Boolean difference, namely, volumes belonging to one or the other model but not both, is minimized.

Comparing two different models provides evidence of reabsorption or deterioration of bone indicating need for intervention, or evidence of normal growth in the case of a young person whose body is still growing, or evidence of ingrowth as a way of monitoring recovery after surgery. In the case of an implant made of reabsorbable material, this may provide a way of monitoring the extent of reabsorption. It may also be useful, as described earlier, to compare MRI and CT scans taken from the same patient, at either the same or different times. Having the facility of a central website makes this easier and provides a capability which might not be available at every doctor's office.

Dimensions may not be the only parameter that can be usefully compared between multi-dimensional models or raw data taken at different times. Bone density might be able to be compared as an indicator, for example, of osteoporosis or other degenerative condition. Even local chemical composition, which is one of the strengths of MRI as a diagnostic technique, might be able to be compared or analyzed. Having all of this maintained on a central site, which may include specialized software, enables time-variation or progression to be studied which may include various stages in the progression of a degenerative disease, followed by design of a custom implant, followed by noting the appearance after implantation of the custom implant, followed by monitoring any changes in nearby bone after implantation, and even including indication of how much reabsorption has taken place in the case of a reabsorbable implant.

The computer facilities for converting an individual CT or MRI scan into a multi-dimensional model may not exist in every doctor's office, and similarly the computer facilities for comparing two different multi-dimensional models and detecting small dimensional changes are even less likely to exist in every doctor's office. Thus, the use of telecommunication such as the Internet provides the availability of such services to any location having appropriate communication facilities, regardless of geographic location.

In the case of an implantable drug delivery device, measuring the remaining size of the implantable drug delivery device could provide indication of how much drug has been delivered so far. In all cases, it would be desirable for communication with the central website or facility to be encrypted, as mentioned earlier and as is known in the art.

In some instances, the present invention may be used in a way which does not involve manufacturing to order, but rather involves selecting the best fit from a stock of already-manufactured components. While selection from stock does not provide all of the advantages of manufacturing completely customized parts to order, it nevertheless would provide some degree of customization that might be adequate for certain purposes. It also would be even faster than fully customized manufacture. In this sort of application, the central website would still receive radiographic data pertaining to a specific patient, and could assist in deciding which stock item should be used. The stock item would then be shipped to the doctor/patient. In this mode of operation, the central website would have further usefulness in that it could be used for maintaining records of inventory, records of rates of use, and could indicate the need for replenishing items which are out of stock or nearly out of stock. Of course, similarly, for custom manufacturing, the website could still help to maintain inventories of predict usage patterns and inventories of raw materials.

One application of the present invention includes the providing of reconstructive or cosmetic implants to augment the bony material of the human jaw. In the United States there are approximately 20 million people who have lost all the teeth from at least one jaw. There are also other people who have lost many individual teeth. When all or many teeth are missing, especially from the lower jaw, the bone gradually disappears by reabsorbing back into the body because of lack of mechanical stimulation or for other reasons. Eventually this affects the facial appearance. Buildup of the jaw with replacement bone from the same person (autograft) or from cadavers (allograft) can remedy this problem but typically this is only a temporary solution because over several years the grafted bone reabsorbs for the same reasons that the original bone reabsorbed.

One solution is to implant a custom-shaped piece of artificial bone at least part of which is made of a material that is not reabsorbable. For example, current work on an alveolar ridge replacement focuses on using hydroxyapatite powder as the basic material. Hydroxiapatite is not reabsorbable into the human body. An example of a binder that may be dispensed onto hydroxyapatite powder to build parts is an aqueous solution of polyacrylic acid (PAA). Following dispensing of the binder, the “green” (uncured) ceramic part is heated to decompose the binder and then heated to a higher temperature to cause sintering thus fusing particles together. The porous sintered ceramic may then be infused with a polymer to further enhance its mechanical strength, such as polymethylmethacrylate (PMMA). Such parts may then be surgically installed in the jaws of patients.

For completely edentulous patients it is possible that a variety of standard sizes may suffice, but it is also possible that parts manufactured from patient-specific data may be preferable. For partially edentulous patients, each with their own pattern of missing teeth, there may be more need for patient-specific manufacturing. In all of these cases, the use of a computer network to transmit patient-specific data is valuable, as is the use of the computer network to transmit patient-specific data such as visualizations back from the central location to the patient location.

The alveolar ridge is not by any means the only body part for which it may be useful to manufacture replacement pieces of possibly custom-shaped bone-like material possibly including internet transfer of data to provide exceptionally fast response and delivery time. Other possible body parts, shapes and devices include: cranial plugs; cheeks; mandible onlay; mandible extension; chin; nose; dental plug; external ear; gauze; orbital implants; orbital floor; orbital wall; orbital rims; orbital socket; croutons; wedges; plates; sheets; blocks; dowels; spine cage inserts; screws; tacks; custom pieces; cartilage; and soft tissue. These body parts are not meant as a complete or limiting list; others are also possible.

The term “croutons” refers to pieces of bone-like material that are used during surgery to fill voids in bone such as in piecing together complex fractures, thereby improving the likelihood of successful healing. They can be thought of as building blocks. Their shapes may be standard or custom or a hybrid and they may or may not include features for attachment. Wedges, sheets, plates, blocks and dowels are basic shapes similar to croutons. Orbital implants, rims, sockets, floors and walls are portions of the bone near the eye. Dental plugs are small pieces of bone substitute that could be placed at the site of a tooth extraction. A cranial plug would be used to fill a hole made in the skull for surgical purposes.

Some of these such as the external ear, and perhaps the nose, are non-rigid and would be made out of silicone or polyethylene, but again these are merely examples and other materials are also possible. For devices that are desired to be reabsorbable into the human body, examples of suitable materials are poly-L-lactic acid (PLLA) and poly-lactic-co-glycolic acid (PLGA), and similar polyesters. Suitable printing techniques take advantage of the solubility of these materials in chloroform.

Implantable drug delivery devices contain drugs and are made of a material that slowly degrades or dissolves in the body. Their function is to release drug gradually as they dissolve. The time scale of drug release is typically of the order of months, perhaps many months. Implantable drug delivery devices would typically be implanted by a relatively minor implantation procedure.

Another type of device manufacturable using the present invention is surgical leave-behinds that might contain and release drugs. A surgical leave-behind is placed in a patient's body as a surgical incision is being closed, with the intention that it release drugs as it dissolves. Surgical leave-behinds are essentially a form of implantable drug delivery devices, which is implanted during a surgical procedure that is performed primarily for other reasons. Their designed release period is determined by the time scale of processes that take place during wound healing and recovery from surgery and is typically measured in days.

Categories of drugs that might likely be packaged in surgical leave-behinds include local anesthetics, anticoagulants, antibiotics, chemotherapeutic or other anti-cancer drugs, anti-nausea drugs, growth factors hormones or similar substances to promote healing, and the like. Both implantable drug delivery devices and surgical leave-behinds could quickly be made-to-order, with unique specification of geometry, content of drug or drugs, dosage, dissolution time, or any other design variable, in part through the use of the internet, using the methods described herein.

The method of the present invention can also be used to quickly generate and deliver tissue scaffolds of customized shape, composition, and the like. A tissue scaffold is a device having some porosity or internal voids which are designed so that cells tend to grow into them. In some instances cells are seeded into the scaffold in advance of when the device is to be implanted in a person's body, and are allowed to grow for a period of time in an environment conducive to their growth, such as a bioreactor. Often the scaffold is further designed to dissolve or be absorbed by the body or the surrounding medium over a certain period of time, which then provides further spaces into which cells may grow.

The geometry or architecture of a tissue scaffold has a significant effect on how well cells grow into it. The overall dimensions and geometry of the scaffold may be something that needs to be designed for the dimensions of an individual patient, or other features of it may need to be customized for an individual patient. Other features of the design of a tissue scaffold which may affect its success in growing cells include composition of bulk materials and surfaces, deposition in specific places of surface-active agents which may either increase or decrease hydrophobicity, and deposition in specific places of bioactive materials, such as growth factors, and peptides. Use of the Internet for data transmission, possibly including patient-specific data, together with use of the rest of the techniques disclosed herein, can significantly speed up the availability time of custom-made or patient-specific tissue scaffolds.

In yet another embodiment, the present invention provides a new method of rapid design and manufacture of custom pharmaceuticals drugs such as Oral Dosage Forms (ODF) (pills); short-run applications to meet small, acute or emergency needs; via transmission of data over computer networks. In general the process would be what has already been described but simpler in that it would not require transmission of any detailed graphical data either from or to a doctor. Today most simple pills of common pharmaceuticals are of constant composition throughout and are made by pressing powder into a tablet shape.

Currently, there is a need for designing and manufacturing more complicated geometries of pills which would provide for delayed or gradual release of active pharmaceuticals, sequenced release of more than one pharmaceutical in a single pill, and in general somewhat arbitrary release profiles of multiple active pharmaceutical ingredients, all governed by the geometric design of the pill and the dissolution behavior of appropriate portions of the pill in bodily digestive fluids. For example, there may be a desire to combine multiple pharmaceutical compounds in a single oral dosage form as a way of improving patient compliance and accuracy in following instructions for self-administering medications. In general, in all sorts of medical treatments, noncompliance is a significant source of error or failure. Noncompliance can include patient unwillingness to take drugs, and also patient error in taking drugs. Compliance of patients would be increased by anything that decreases the number of pills that must be taken and/or decreases the number of times per day that pills must be taken. This may be useful, for example, in connection with treating either elderly or very young patients. For example, it may be desirable to combine, in one oral dosage form, a first medication with another medication to counteract side effects of the first medication (e.g., nausea).

There may further be reason for one drug or medication to be time-delayed with respect to the other drug or medication. There may be so many possible combinations of drugs that it is not practical to pre-manufacture very many combinations of them, and yet with internet-enabled communications and rapid manufacturing techniques, such customization and made-to-order pills would be practical. This would also enable doctors to adjust doses based on patient response or patient-unique factors, including individually adjusting doses of each of multiple medications contained within an Oral Dosage Form. This resembles trends in other manufacturing industries, even for products as complicated as automobiles, to cut inventories and to offer more individualized and yet still rapid response to customer needs by manufacturing-to-order. The use of the Internet helps to enable such a system to offer several-day or even faster turnaround, a convenience that can significantly change the way in which pills are made and delivered to patients.

The manufacturing of the ODF can be done by three dimensional printing, layering of premade sheets, or some combination of the these or related techniques. The present invention allows the prescribing physician to transmit the desired prescription for specified active pharmaceutical ingredient(s), dosages, and customized release profile and/or sequence via a computer network, such as the Internet, to a manufacturing location, and have pills manufactured to order with the prescribed quantity and release profile of active pharmaceutical ingredients. These customized pharmaceuticals can then be delivered directly to the patient. Again, the use of computer networks means that even if only a few manufacturing locations exist, it is possible for these products to be delivered to patients quickly, in a cost efficient manner, and with minimal geographic limitations.

Additionally, a secure web site can serve many related functions relating to record keeping of a patient's usage of pharmaceuticals, recording the issuance of prescriptions from doctors, checking for interactions with other drugs which the patient may be taking, refilling a prescription or limiting the number of refills of a prescription, and sending follow-up notices to either the physician or the patient. Billing can also be accomplished through such a web site, and interaction between the physician, patient, and insurance company can be facilitated. Product design updates, client feedback and follow-up notices to users can also be accomplished through such a web site, as can generation of statistical data. This method can include transmittal of information back to the prescriber at the time of prescribing, before finalizing of the order, or later. Such information can be maintained on a secure web site that is made available to appropriate categories of users, possibly including the use of encryption, or passwords.

In addition to implants, which would be defined as objects which are totally enclosed inside the body when they are put into use, the same techniques could also be used for manufacturing tooth substitutes or parts of teeth via communication of dimensional information to a distant site for manufacture. This could be done either in conjunction with reconstruction of maxillofacial bone products as already described, or separately. In the case of separately, it could be used to fabricate objects, e.g., dental implants, dental onlays, dental inlays, dental crowns, dental caps, etc., i.e., objects which are not at all enclosed by the skin of the body and which are visible when installed.

All of the above U.S. patents and applications are incorporated by reference. Aspects of these U.S. patents and applications can be employed with the teachings of the invention to provide further combinations.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method in a computer system for customized design and manufacture of an anatomically correct implant customized for a patient, comprising:
producing a radiological image of an anatomical body part or bone that is to be replaced, repaired or augmented;
converting the radiological image into a format transmittable over a computer system;
creating a computer based multi-dimensional model based on the converted patient specific radiological image;
modifying the multi-dimensional model using the computer system; and
manufacturing an implant according to the modified model using three-dimensional printing techniques.

2. The method of claim 1, further comprising compositional design within the multi-dimensional model that are translated into the manufactured implant.

3. The method of claim 1, further comprising transmitting the multi-dimensional model to a client for approval prior to manufacturing the biomedical implant.

4. The method of claim 1, further comprising growth factors, comb polymers, or other substances having biological activity.

5. The method of claim 1, further comprising markers for future radiological viewing.

6. A method for manufacturing and selling individually fitted customized biomedical devices for a given recipient via a computer network, comprising:
capturing data in a computerized form;
converting the data to a multi-dimensional model;
modifying the multi-dimensional model to include an internal architecture,
converting the modified multi-dimensional model into machine instructions;
manufacturing a customized biomedical device from the machine instructions wherein the biomedical device is anatomically correct to the individual patient; and
shipping the biomedical device to the recipient for implantation.

7. The method of claim 6, further comprising transmitting the modified multi-dimensional model to the recipient for further modification prior to converting the model into machine instructions.

8. A method for manufacturing and selling customized medical devices via a computer network, comprising:
transmitting patient-specific data from a patient location to a secure web site via a computer network;
manufacturing the medical device based on the transmitted data;
delivery of the medical device; and
maintaining records of the patient-specific data.

9. The method of claim 8, further comprising generating follow-up notices based on the maintained records.

10. The method of claim 8 wherein the medical device is an oral dosage form containing one or more active pharmaceutical ingredients.

11. The method of claim 8 wherein the medical device is an implantable drug delivery device containing one or more active pharmaceutical ingredients.

12. The method of claim 8 wherein the medical device is manufactured by three dimensional printing.

13. The method of claim 8 wherein manufacturing the medical device further includes selecting the best fit implant from a group of already-manufactured implants.

14. An Internet-enabled method for designing and manufacturing biomedical devices comprising: using an Internet-enabled system to transmit radiological images to a central server;
converting the radiological images into a digital format;
transmitting the digital format of the radiological images to the central server operably connected to a manufacturing station; and
manufacturing the biomedical device in accordance with the radiological image.

15. The method of claim 15, further comprising creating a multidimensional model from the digital format of the image and transmitting the model to a client for modification.

16. The method of claim 15 wherein manufacturing the biomedical device in accordance with the radiological image includes selecting a best fit from a plurality of already manufactured medical devices.
